(19) United States
(12) Patent Application Publication
(10) Pub. No.: US 2009/0099958 A1
(43) Pub. Date: Apr. 16, 2009

(54) Method for use in determining the value of an automobile

(76) Inventor: Kok Peng Choi, Kuala Lumpur (MY)

Correspondence Address: COLLEN IP, THE HOLYOKE MANHATTAN BUILDING, 80 SOUTH HIGHLAND AVENUE, OSSINING, NY, 10562, US

(21) Appl. No.: 12/034,992

(22) Filed: Feb. 21, 2008

(30) Foreign Application Priority Data
Oct. 12, 2007 (MY) 20071771

(51) Int. Cl. G06Q 40/00; G06F 17/10

(52) U.S. Cl. 705/38

(57) ABSTRACT

Method for use in Determining the Value of an Automobile The present invention discloses a method for providing increased underlying value of an automobile based on the number of year(s) within a period of a conventional hire-purchase contract or term loan. Accordingly, the underlying value is increased each year within the said period and therefore the owner may re-sell the automobile at a higher price, prior or after completion of the hire-purchase contract or term loan.

### FIELD OF INVENTION

The present invention relates generally to a method determining the underlying value of an automobile; wherein the said method provides increasing value of the said automobile, for each year within a term loan or a hire purchase contract.

### BACKGROUND OF THE INVENTION

A vehicle purchasing process involves various fundamental factors to be accordingly evaluated by the purchaser as it can be considered as a long term investment. The vehicle or specifically automobile can be purchased new or used. In most cases, a purchaser or a prospective owner will apply for a loan from a financial institution to provide payment for the respective car dealer and thus subscribe to the loan repayment scheme with the said financial institution.

The common and conventional way for vehicle acquiring scheme involves the consumer to provide periodical payments of the principal loan amount, spread over a predetermined amount of years. In this context, it can be considered that the consumer is provided with a predetermined term or period to acquire total ownership of his/her vehicle from the respective financial institution.

Comprehendingly, in most vehicles or specifically automobile acquiring by way of loan repayment or hire purchase cases, the financial institution may add in a predetermined amount of interest based on the interest rate which is normally fixed by the said financial institution, in addition to an initial payment of at least 10% from the principal amount. Such rate may be subjective to the term of principal loan repayment. Accordingly, the longer it takes to complete the full payment, the higher the interest amount will be incurred in addition to the periodical payment. In addition to this, a significant number of financial institutions incur high interest rates which may be a core encumbrance for prospective owners in relation to purchasing automobiles via a term loan. In order to alleviate this common tribulation, prospective owners normally increase their monthly or periodic payments so as to reduce the term of loan and thus reduce the amount of interest to be paid.

Other drawbacks include the meager re-sell value or underlying value in the event that the owner wishes to auction the automobile upon completed or even prior to the completion of loan term payment or hire purchase contract.

Following the above and due to the industry's rapid growth, there is tremendous need to ease or improve the current methods and schemes, in order to alleviate the common tribulations in relation to automobile loan repayment, and thus provide prospective automobile owners with beneficial schemes, particularly in assisting to increase the re-sell value of the vehicle.

Consequently, a number of financial institutions and professionals endeavor to assist prospective automobile owners in providing several methods and schemes having reduced amount of interest or provide more convenient re-payment schemes, based on their financial capabilities.

However, many of these former methods do not solve another noteworthy tribulation in relation to automobile acquisition via term loan with a financial institution; said tribulation is re-selling value of the acquired automobile, after they have acquired the automobile, for instance after 9 years, subjective to the loan term. In many cases the re-selling value or referred herein as the underlying value of an automobile depends significantly on the underlying value of the automobile.

For instance, in the event that an owner wishes to auction the automobile prior or upon completion of the term loan provided by a financial institution, the re-sell value is generated from the underlying value of the said automobile. Such value may be evaluated and thus determined based on various aspects, generally on the automobile physical specification, which may include the year of manufacture, current physical shape, and collision history (if any). Alternatively the price of the automobile for auction may be based on the residual value of the said automobile. Normally, the underlying value or residual value of an acquired automobile by way of a term loan is reduced to approximately 50% or lower of the principal amount, upon completion of the loan term or hire purchase contract.

Proceeding from the above, and considering the fluctuations of most automobiles prices at the end of the loan term due to depreciation process, it would be desirable to develop a method or scheme to solve a prospective automobile owner's tribulations in relation to re-selling the said owner's automobile when desired prior to or after the completion of the loan term or hire purchase contract obtained from the financial institution.

It is therefore an object of this invention to provide a method that overcomes the tribulation associated with the underlying value of an automobile.

The present invention provides an alternate method in which the underlying value of an automobile is increased for every subsequent year of the term loan or hire purchase contract.

It is further a great advantage to provide a method for providing a simple and reliable underlying automobile value increment automobile value methodology.

The present invention includes the respective formulation for providing the main objective in regards to increasing the underlying value of an automobile.

Other objects and features will be apparent from the following detailed description of preferred embodiments.

### SUMMARY OF THE INVENTION

The present invention discloses a method for use in a term loan or hire purchase contract in determining the value of an automobile; said method comprising: a residual value of the said automobile; an interest rate of the said term loan or hire purchase contract; obtaining a multiplying value for each year of the said term loan or hire purchase contract in consideration of the said interest rate;

calculating the underlying amount of the automobile for each year within the said term loan or hire purchase contract in consideration of the said multiplying value for any year of the said term loan or hire purchase contract and the obtained residual value of said automobile.

### DETAILED DESCRIPTION OF THE INVENTION

The present invention provides an effective and simple methodology for projecting increased underlying value of an automobile, wherein said underlying value is increased every year within the period of the re-payment of the loan or based on the hire purchase contract obtained for acquiring the said automobile.

The present invention may provide an effective long term investing method in relation to monetary rate of return of the acquired automobile.

The method of the present invention takes into consideration 3 fundamental factors, wherein these factors are multiplying factor or value, the residual value of the automobile and the number of years involved, said years may serve as the “investment period”.

Accordingly, with the implementation of the method of the present invention, the underlying value of an automobile is increased each year within the said period and therefore the owner may re-sell the automobile at a reasonable price, prior or after completion of the hire-purchase contract or term loan. It can be concluded at one point that the higher amount of years involved, the higher the return rate will be, in accordance to one preferred embodiment of the present invention.

The “underlying value multiplying factor” is expressed in a numerical fractions involved for calculation or determination of the underlying amount.

The “underlying amount” is the total amount which may be obtained in monetary term as a result to the calculation of the underlying value of the automobile using the formulation of the present invention.

The “loan amount” of the loan is the original amount of loan which is involved in the hire-purchase contract or term loan.

The “initial underlying asset amount” or value is the initial amount to be compounded for a period based on the term loan or hire purchase contract.

It should be noted here that the initial underlying asset or value of an automobile is significantly dependant on the interest rate imposed by the financial institution. Basically, a lower interest rate will result to a higher initial underlying asset.

The “compounded amount” is the compounded underlying asset of the automobile within the end of respective year of the period based on the term loan or hire purchase contract.

As briefly discussed in the preceding paragraph, the most common method of obtaining an automobile apart from cash payment is by way of a term loan or hire-purchase contract, from a financial institution, wherein the said loan is calculated based on the amount for purchasing the automobile from a car dealership.

The loan therefore provides periodical payment over a number of years, normally spread over 9 years. The owner may provide a predetermined amount of down payment (initial payment)—which is typically at 10% of the principal amount; and thus the remaining amount is then spread over the 9 years for periodical payment.

Accordingly, upon obtained the term loan or hire-purchase contract for acquiring the automobile, the owner is required to provide payment for a predetermined amount for every month of the said 9 years. In this instance, the underlying asset of the automobile is generated at a predetermined amount. After several years, the owner may wish to auction the automobile prior to completion of the term loan. Conventionally, the owner may project the auction value or amount based on the underlying asset of the automobile is generated, which is based on the depreciation process.

However, using or subscribing to the method of the present invention, the owner may obtain compounded monetary return at the end of term of loan. This is as a result to the increased underlying value of the automobile at the end of the said term loan.

Suitably, the 9 years period selected by the owner in regards to the contract may serve as a “period for investing” in regards to the compounding method or effect used for the present invention, while the compounding rate may be based on the interest rate provided by the financial institution.

In accordance to the method of the present invention is based on a conventional compounding method, wherein the each value which is provided preferably in decimal fraction, in the below table is obtained by multiplying factor, and the interest rate incurred herein is preferably at 10%. However it should be noted that the interest rate may vary and it is dependant to the initial underlying asset of the said automobile, as mentioned earlier.

In order to obtain the multiplying factor; the financial institution may provide an interest rate at 10%, in decimal fraction of 0.1. In this formula, unlike a conventional compound interest formula for a term loan which may be implemented by the said financial institution, the said rate is added to one.

$$10 / 100 + 1 = 1.1000$$

Accordingly, the subsequent compound value for each year is obtained by way of:

1.1000(1.1000)=1.2100;

1.1000(1.2100)=1.3310; and so forth.

Based on the above formulation, the subsequent multiplying value for each year is calculated by multiplying the multiplying factor by itself based on the number of year(s).

For instance in the event that the number of years is 3; therefore;

(1.1000)³=(1.1000)(1.1000)(1.1000)=1.331

The complete multiplying factor or value for each year is as below based on 9 years term.

| YEAR (BASED ON HIRE- | COMPOUNDING |
|---|---|
| PURCHASE CONTRACT) | MULTIPLYING VALUE |
| First | 1.1000 |
| Second | 1.2100 |
| Third | 1.3310 |
| Fourth | 1.4641 |
| Fifth | 1.6105 |
| Sixth | 1.7716 |
| Seventh | 1.9487 |
| Eighth | 2.1436 |
| Ninth | 2.3579 |

In order to obtain the initial underlying asset of the automobile, the loan amount is divided with the compound multiplying value for the ninth year.

For example, based on the above table which is calculated in consideration of a 10% interest rate from the bank, and the loan amount for instance is RM 80,000, the underlying asset value is;

$$RM 80 , 000 / 2.3579 = RM 33 , 928$$

The operational mode of the present invention will be further elucidated with the following examples and scenarios.

### EXAMPLE 1

Referring to the said table, in the event that the loan amount or hire-purchase amount is RM 90,000, the underlying asset amount at the end of the contract or loan term provided may be RM 38,200. Using the method of the present invention said underlying value of the automobile can be increased in accordance to the number of years the owner has made payment for.

For instance, the owner may wish to auction the automobile at the 2.6 years of the contract. With the implementation of the present invention, the initial underlying asset value of the said automobile is RM 46,222 which is calculated as with Formulation C of the present invention, as shown below:

$$IV ( Mf for the respective year )$$

IV is the initial underlying asset amount of the automobile; and

Mf is the Multiplying Value for the respective year

Therefore;

$$RM 38 , 200 ( 1.2100 ) = RM 46 , 222$$

### EXAMPLE 2

As a second exemplary, in the event that the loan amount or hire-purchase amount is RM 150,000, the initial underlying asset value of the automobile which is set aside is RM 63,700. Using the method of the present invention said underlying amount may be increased in accordance to the number of years the owner has made payment for. For instance, the owner may wish to auction the automobile at the 6.2 years of the contract. With the implementation of the present invention, the underlying amount of the said automobile is RM 112,851, instead of RM 63,700, which is calculated as below:

$$RM 63 , 700 ( 1.7716 ) ( based on Table 1 ) = RM 112 , 851$$

### EXAMPLE 3

As a third exemplary, in the event that the loan amount or hire-purchase amount is RM 85,000, the initial underlying amount which may be set aside is RM 34,860. Using the method of the present invention said underlying amount may be increased in accordance to the number of years the owner has made payment for. For instance, the owner may wish to auction the automobile at the 8^{th} year of the contract. With the implementation of the present invention, the underlying amount of the said automobile is RM 85,000, instead of RM 34,860, which is calculated as below:

$$RM 34 , 860 \times 2.1436 ( based on Table 1 ) = RM 74 , 340$$

It is noted that compounded amount of the present invention is preferably collected by the respective owner at the end of the loan term or hire purchase contract.

The present invention may operate differently based on the suitability of the circumstances of the owner is in.

Appended below are the several scenarios which may occur during the course of the term loan or hire purchase contract.

Scenario 1

An owner who is subscribed to the method of the present invention is entitled to obtain the compounded amount at the end of the term loan or hire purchase contract. In the event that the interest rate imposed by the bank is 10% and the loan amount is RM 80,000, the initial underlying amount is therefore calculated as:

RM 80,000/2.3579=RM 33,928

In the event that the owner decides to fully acquire the automobile, and thus completed the payment of 9 years, the owner is entitled to receive following amount:

RM 33,928(2.3579)=RM 79,998

Scenario 2

An owner, referred herein as Owner A, who is subscribed to the method of the present invention is entitled to obtain the compounded amount at the end of the term loan or hire purchase contract. In the event that the interest rate imposed by the bank is 10% and the loan amount is RM 80,000, the initial underlying amount is therefore calculated as:

RM 80,000/2.3579=RM 33,928

At the end of year 6, the owner may wish to sell the automobile. In accordance to the conventional term loan method, based on the given details of 10% interest rate spread over 9 years; the owner should have paid approximately RM 58,508, therefore the said owner is still in debt of at least RM 29,492 with the bank. However, in accordance to the present invention, at the same period, the owner is entitled of a compounded underlying value of the automobile at RM 60, 106, which can be calculated as follows:

RM 33,928(1.7716)=RM 60,106

Due to the depreciation process of the automobile, the owner may be able to sell the said automobile at a meager amount of approximately RM 30,000, although the compounded underlying amount is RM 60,106. The latter amount is basically the amount that the owner is entitled to, for selling the automobile to another owner, referred herein as Owner B at the end 6^{th} year.

Owner A will receive the said amount of RM 60,106 at the end of the term loan or hire purchase contract.

Owner B which is in this case is the new owner of the said automobile resumes payment from the 7^{th} year and may continue to complete the term of the loan or hire purchase contract. Accordingly, at the end of the term, the Owner B is entitled to the following amount:

Total compounded amount for 9^{th} Year—RM 60,106;

RM 79,998−RM 60,106=RM 19,892

Based on the above, Owner B is entitled to receive RM 19,892 of the compounded amount, at the end of the loan term.

Scenario 3

In another scenario, an owner, referred herein as Owner A, who is subscribed to the method of the present invention is entitled to obtain the compounded amount at the end of the term loan or hire purchase contract. In the event that the interest rate imposed by the bank is 10% and the loan amount is RM 80,000, the initial underlying amount is therefore calculated as:

RM 80,000/2.3579=RM 33,928

At the end of the 3^{rd} year, Owner A may decide to sell the automobile to another owner, referred herein as Owner B. With the method of the present invention, at the end of the 3^{rd} year, Owner A is entitled to the following amount at the end of the term of the loan or hire purchase contract:

RM 33,928(1.33100)=RM 45,158

Accordingly, Owner B resumes payment from the 4^{th} year. However, by the end of 6^{th} year, Owner B decides to sell the car to Owner C, wherein Owner C resumes payment from the 7^{th} year and continues to complete the term of the loan or hire purchase contract.

Considering the above, the compounded amount of Owner B at the end of 6^{th} year at the end of the loan term or hire purchase contract is calculated as the following;

Compounded amount at the end of 6^{th} year (X)=RM 60,106

Compounded amount at the end of 3^{rd} year (Y)=RM 45,158

Compounded amount entitled to Owner B(X−Y)=RM 14,948

The compounded amount for Owner C is calculated as the following:

Compounded amount at the end of 9^{th} year (T)=RM 79,998

Compounded amount at the end of 6^{th} year (W)=RM 60,106

Compounded amount entitled to Owner C(T−W)=RM 19,892

As can be seen by the scenarios and examples, although not limiting to; the underlying value is substantially increased for each year by way of compounding effect; therefore the auction value of the automobile is as well significantly increased to the satisfaction of the owner. Suitable, the benefits of the present invention are:

Comprehendingly, the period of the hire-purchase contract may vary, however the main objectives of the present invention can still be accordingly achieved.

The benefits of the present invention may include:
1. Increment of automobile auction value;
2. Total periodical payment for each month remains stagnant based on the hire-purchase contract, although the underlying value of the automobile increases per year;
3. Simple and reliable methodology.

Exemplary embodiments have been accordingly described above. Those skilled in the art will appreciate that changes may be made to the embodiment described without departing from the scope of the present invention.

1. A method for use in a term loan or hire purchase contract in determining the value of an automobile; said method comprising:
an initial underlying asset amount of said automobile;
an interest rate of the said term loan or hire purchase contract;
obtaining a compounding multiplying value for each year of said initial underlying asset amount in consideration of the said interest rate;
calculating the value of the automobile for each year within the said term loan or hire purchase contract in consideration of the said multiplying value for any year of the said term loan or hire purchase contract and the obtained initial underlying asset amount of said automobile;
wherein the initial underlying asset amount of the automobile is calculated in consideration of the loan amount and the compound multiplying value for the final year of the said term loan or hire purchase contract.

2. The method as claimed in claim 1 wherein the multiplying factor or value is based on the interest rate, for example in the event that the interest rate is 10%, the multiplying factor is 1.1000.

3. The method as claimed in claims 1 wherein the subsequent multiplying factor for each year within the said term loan or hire purchase contract is obtained by multiplying the obtained multiplying factor with the by itself based on the number of year(s).

4. The method as claimed in claim 1 wherein the calculation of the value of the automobile is based on the formulation IV (Mf for the respective year).

5. The method as claimed in claim 1 wherein the higher the interest rate, the lower the initial underlying asset amount.
